(19) United States
(12) Patent Application Publication
(10) Pub. No.: US 2025/0162657 A1
(43) Pub. Date: May 22, 2025

(54) VEHICLE LOWER PART STRUCTURE

(71) Applicant: TOYOTA JIDOSHA KABUSHIKI KAISHA, Toyota-shi (JP)

(72) Inventors: Nobuyuki ITAI, Toyota-shi (JP); Koji SAEKI, Okazaki-shi (JP); Keisuke TOYOTA, Toyota-shi (JP); Toshio MURATA, Toyota-shi (JP)

(73) Assignee: TOYOTA JIDOSHA KABUSHIKI KAISHA, Toyota-shi (JP)

(21) Appl. No.: 18/823,701

(22) Filed: Sep. 4, 2024

(30) Foreign Application Priority Data
Nov. 22, 2023 (JP) 2023-198547

(51) Int. Cl. B62D 25/20; B60K 1/04

(52) U.S. Cl. CPC B62D 25/20; B60K 1/04; B60K 2001/0438

(57) ABSTRACT

The vehicle lower part structure is formed in a frame shape including a pair of left and right first frames extending in the vehicle longitudinal direction, and a pair of front and rear second frames provided and extending in the vehicle width direction, and a frame-shaped member capable of accommodating a battery inside, a battery cover provided on an upper surface of the frame-shaped member and extending in the vehicle longitudinal direction and the vehicle width direction, and a pair of left and right first frames extending in the vehicle width direction and connecting, and a cross member protruding upward from the battery cover to the vehicle cabin.

### CROSS-REFERENCE TO RELATED APPLICATION

This application claims priority to Japanese Patent Application No. 2023-198547 filed on Nov. 22, 2023, incorporated herein by reference in its entirety.

### BACKGROUND

### 1. Technical Field

The present disclosure relates to a vehicle lower part structure.

### 2. Description of Related Art

Chinese Patent Application Publication No. 114940214 discloses a structure in which a battery housing space is formed inside a vehicle body frame. In the structure of Chinese Patent Application Publication No. 114940214, a battery cover is disposed on the upper surface of the vehicle body frame, and a cooling plate is disposed on the lower surface of the vehicle body frame.

### SUMMARY

In the structure described in Chinese Patent Application Publication No. 114940214, however, a framework member such as a floor cross member for reinforcing a vehicle cabin needs to be fixed to the battery cover. There is room for improvement in ensuring collision resistance performance against a collision such as a side collision.

An object of the present disclosure is to provide a vehicle lower part structure in which collision resistance performance can be ensured.

A vehicle lower part structure according to one aspect includes:
a frame-shaped member having a frame shape including a pair of right and left first frames extending in a vehicle front-rear direction and a pair of front and rear second frames extending in a vehicle width direction, the frame-shaped member being configured to house a battery inside;
a battery cover provided on an upper surface of the frame-shaped member and extending in the vehicle front-rear direction and the vehicle width direction; and
a cross member extending in the vehicle width direction, connecting the right and left first frames, and protruding into a vehicle cabin above the battery cover.

The vehicle lower part structure according to the above aspect includes the frame-shaped member including the right and left first frames extending in the vehicle front-rear direction and the front and rear second frames extending in the vehicle width direction, and the battery can be housed inside the frame-shaped member. The battery cover is provided on the upper surface of the frame-shaped member, and extends in the vehicle front-rear direction and the vehicle width direction. Accordingly, the battery housed inside the frame-shaped member can be covered from above by the battery cover.

The cross member extending in the vehicle width direction and connecting the right and left first frames is provided. The cross member protrudes into the vehicle cabin above the battery cover. Accordingly, the cross member can function as a floor cross member for reinforcing the vehicle cabin.

In the vehicle lower part structure according to the above aspect, both ends of the cross member may be laid on upper surfaces of the first frames.

In the vehicle lower part structure according to the above aspect, a downward load acting on the cross member can be received by the first frames.

In the vehicle lower part structure according to the above aspect, the cross member may include an attachment portion for attachment of a vehicle seat.

In the vehicle lower part structure according to the above aspect, a load from the vehicle seat can be transmitted to the frame-shaped member via the cross member.

In the vehicle lower part structure according to the above aspect, a rocker extending in the vehicle front-rear direction may be provided outside the frame-shaped member in the vehicle width direction, and the first frame may be attached to the rocker.

In the vehicle lower part structure according to the above aspect, a load input to the rocker in the event of a side collision can be received by the frame-shaped member. Further, the load can be transmitted to a rocker on an opposite side to the collision side via the frame-shaped member.

In the vehicle lower part structure according to the above aspect, the battery cover may be a floor panel constituting a floor surface of the vehicle cabin.

In the vehicle lower part structure according to the above aspect, it is not necessary to provide a separate floor panel by using the battery cover as the floor panel.

As described above, with the vehicle lower part structure of the present disclosure, the collision resistance performance can be ensured.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side sectional perspective view schematically illustrating a main part of a vehicle to which a vehicle lower part structure according to an embodiment is applied;

FIG. 2 is a cross-sectional view taken along II-II line of FIG. 1; and

FIG. 3 is a cross-sectional view taken along III-III line of FIG. 1.

### DETAILED DESCRIPTION OF EMBODIMENTS

The vehicle lower part structure 10 according to the embodiment will be described with reference to the drawings.

### Overall Configuration of the Vehicle Lower Part Structure 10

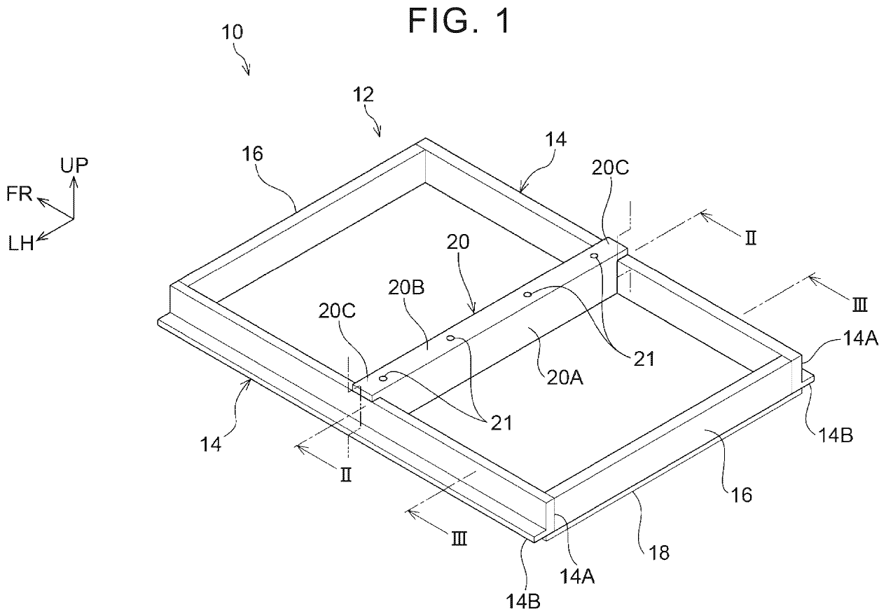

FIG. 1 is a side sectional perspective view schematically showing a main part of a vehicle to which a vehicle lower part structure 10 according to an embodiment is applied. Note that the arrow FR, the arrow UP, and the arrow LH in the drawing indicate the vehicle front direction, the vehicle upper direction, and the vehicle left direction in the vehicle to which the vehicle lower part structure 10 is applied, respectively. In the following description, when the front, rear, up, down, and left and right directions are used without special mention, the front and rear directions in the vehicle front-rear direction, the up and down directions in the vehicle up-down direction, and the left and right directions in the vehicle left-right direction (width direction) are respectively indicated.

As shown in FIG. 1, the vehicle lower part structure 10 of the present embodiment includes a frame-shaped member 12 disposed at a lower portion of the vehicle. The frame-shaped member 12 is formed in a substantially rectangular frame shape in a plan view, and includes a first frame 14 and a second frame 16.

The first frame 14 is provided in a pair of left and right sides, and is disposed so as to face each other in the vehicle width direction. Each of the first frames 14 extends in the vehicle front-rear direction and is formed in a closed cross-sectional shape.

Here, the first frame 14 is configured to include a side wall portion 14A that extends in the vehicle vertical direction and constitutes a side portion of the frame-shaped member 12, and a flange portion 14B that extends from the lower end of the side wall portion 14A to the vehicle widthwise direction outer side. The first frame 14 is formed in a substantially L-shape when viewed from the vehicle front-rear direction.

The front end portions of the first frame 14 are connected to each other in the vehicle width direction by the second frame 16. Similarly, the rear end portions of the first frame 14 are connected to each other in the vehicle width direction by the second frame 16.

The second frames 16 are provided as a pair of front and rear frames, and are disposed to face each other in the vehicle front-rear direction. Each of the second frames 16 extends in the vehicle width direction and is formed in a closed cross-sectional shape. The material and the manufacturing method of the first frame 14 and the second frame 16 are not particularly limited. For example, the first frame 14 and the second frame 16 may each be formed by extrusion molding of an aluminum alloy or the like. Further, for example, the first frame 14 and the second frame 16 may be integrally formed by casting. Further, the first frame 14 and the second frame 16 may each be formed of a pressed rigid plate or the like.

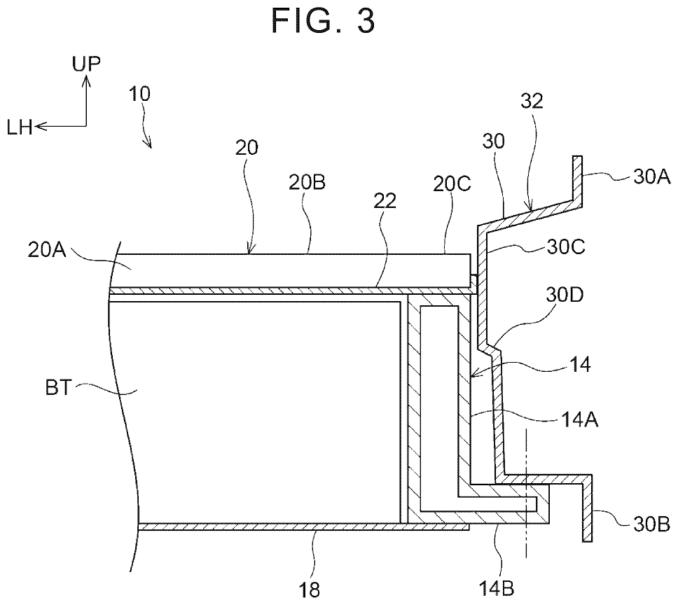

As described above, the frame-shaped member 12 is formed into a frame shape by the pair of first frames 14 and the pair of second frames 16. A battery BT (see FIG. 3) can be accommodated in an inner area of the frame-shaped member 12.

A base plate 18 is provided on the lower side of the frame-shaped member 12. The base plate 18 is formed in a substantially rectangular plate shape having a vehicle vertical direction as a thickness direction, and is fixed to the lower surface of the first frame 14 and the lower surface of the second frame 16. The method of fixing the base plate 18 is not particularly limited, and may be mechanically fastened by a bolt, a rivet, or the like, or may be joined by welding or the like.

A cross member 20 is disposed between the pair of front and rear second frames 16. The cross member 20 extends in the vehicle width direction and connects the pair of left and right first frames 14. That is, the right end portion of the cross member 20 is connected to the first frame 14 on the right, the left end portion of the cross member 20 is connected to the first frame 14 on the left.

The cross member 20 includes a pair of front and rear vertical wall portions 20A extending in the vehicle up-down direction and the vehicle widthwise direction, and a ceiling portion 20B connecting the upper ends of the vertical wall portions 20A to each other. In addition, both vehicle-width-direction end portions of the cross member 20 are supported portions 20C that are superposed on the upper surface of the first frame 14.

Here, a mounting hole 21 serving as an attachment portion for mounting a vehicular seat (not shown) is provided in the ceiling portion 20B of the cross member 20. The mounting holes 21 are provided at four locations on the ceiling portion 20B, and are configured so that seat rails of the vehicle seat can be fixed to each other. The attachment portion is not limited to the mounting hole 21, and may have another structure. For example, a stud bolt may be provided on the ceiling portion 20B, and the stud bolt may be used as an attachment portion of the vehicular seat.

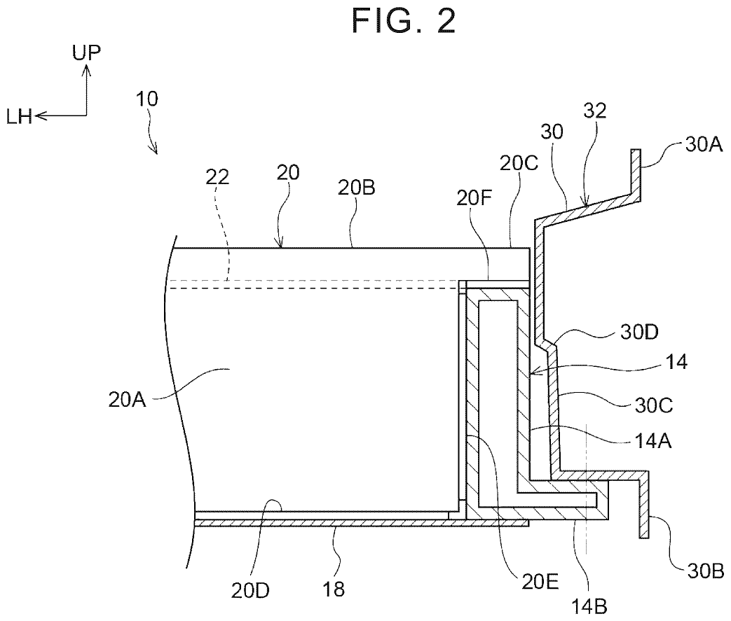

FIG. 2 is a cross-sectional view taken along II-II line of FIG. 1. As shown in FIG. 2, the lower end of the vertical wall portion 20A of the cross member 20 is bent along the base plate 18 to form a lower flange 20D. The lower flange 20D extends in the vehicle-width direction and is superposed on the upper surface of the base plate 18, and is joined to the base plate 18.

The vehicle-width-direction both end portions of the vertical wall portion 20A have a lateral-flange 20E bent along the first frame 14. The lateral flange 20E is joined to the first frame 14 while being superimposed on the side wall portion 14A of the first frame 14.

The lower end of the supported portion 20C of the cross member 20 has an upper flange 20F bent along the first frame 14. The upper flange 20F is joined to the first frame 14 while being superimposed on the upper surface of the first frame 14.

Here, a rocker 30 extending in the vehicle front-rear direction is provided outside the first frame 14 (frame-shaped member 12) in the vehicle width direction, and the rocker 30 includes a rocker inner panel 32 and a rocker outer panel (not shown).

The rocker inner panel 32 is formed in a substantially hat-shaped cross section having an open outer side in the vehicle widthwise direction, and an upper flange 30A extending upward in the vehicle is formed at an upper end portion of the rocker inner panel 32. Further, a lower flange 30B extending downward is formed at a lower end portion of the rocker inner panel 32. The upper flange 30A and the lower flange 30B of the rocker inner panel 32 are respectively joined to the upper flange and the lower flange of the rocker outer panel.

A side wall portion 30C having a substantially C-shaped cross section is formed between the upper flange 30A and the lower flange 30B of the rocker outer panel. The side wall portion 30C extends in the vehicle up-down direction, and a step portion 30D is provided in an intermediate portion of the side wall portion 30C in the vehicle up-down direction. The lower side wall portion 30C is located on the vehicle-width-direction outer side by the stepped portion 30D.

Here, the flange portion 14B of the first frame 14 and the rocker inner panel 32 are fastened by a bolt, a weld nut, or the like. Thus, the first frame 14 (the frame-shaped member 12) is supported by the rocker 30.

A battery cover 22 extending in the vehicle front-rear direction and the vehicle width direction is attached to an upper surface of the frame-shaped member 12.

FIG. 3 is a cross-sectional view taken along III-III line of FIG. 1. As shown in FIG. 3, the battery cover 22 is a plate-like member having the vehicle vertical direction as the plate thickness direction, and the vehicle width direction end portion of the battery cover 22 is bent toward the vehicle upper side along the rocker inner panel 32 and joined to the rocker inner panel 32.

The rocker inner panel 32 is attached to the upper surface of the first frame 14, and a space sandwiched between the battery cover 22 and the base plate 18 serves as a storage space for the battery BT. The battery BT is formed by sealing a case with an electrode assembly in which a plurality of positive electrodes, negative electrodes, and separators are stacked, and in the present embodiment, a plurality of long thin plate-shaped battery BT are arranged in the front-rear direction of the vehicle.

Here, in the present embodiment, the battery cover 22 is a floor panel constituting the floor surface of the vehicle cabin. The cross member 20 protrudes upward from the battery cover 22 to the vehicle cabin.

Note that the cross member 20 and the battery cover 22 may be directly joined to each other, or may be indirectly joined to each other via the first frame 14 or the like.

### Operations

Next, the operation of the vehicle lower part structure 10 according to the present embodiment will be described.

In the vehicle lower part structure 10 according to the present embodiment, as shown in FIG. 1, a frame-shaped member 12 is formed including a pair of left and right first frames 14 extending in the vehicle front-rear direction and a pair of front and rear second frames 16 extending in the vehicle width direction. A battery BT (see FIG. 3) can be accommodated inside the frame-shaped member 12.

Further, as shown in FIG. 3, a battery cover 22 is provided on the upper surface of the frame-shaped member 12, and the battery cover 22 extends in the vehicle front-rear direction and the vehicle width direction. As a result, the battery BT accommodated inside the frame-shaped member 12 can be covered from above (from the vehicle cabin side) by the battery cover 22.

The cross member 20 connecting the pair of left and right first frames 14 protrudes upward from the battery cover 22 to the vehicle cabin. As a result, the cross member 20 can function as a floor cross member for reinforcing the vehicle cabin. As a result, it is possible to ensure the collision resistance performance at the time of collision such as side collision. In particular, in the present embodiment, by using the battery cover 22 as the floor panel, it is not necessary to separately provide the floor panel.

In the present embodiment, as shown in FIG. 2, the supported portion 20C of the cross member 20 is superimposed on the upper surface of the first frame 14. Accordingly, a downward load acting on the cross member 20 can be received by the first frame 14. In particular, in the present embodiment, since the vehicle seat is attached to the cross member 20, the load from the vehicle seat can be transmitted to the frame-shaped member 12 via the cross member 20.

Further, in the present embodiment, since the first frame 14 is attached to the rocker inner panel 32 (rocker 30), the load input to the rocker 30 at the time of side collision can be received by the frame-shaped member 12. Further, a part of the collision load can be transmitted to the rocker 30 on the anti-collision side via the frame-shaped member 12.

Although the vehicle lower part structure 10 according to the present disclosure has been described above, it is needless to say that the present disclosure can be implemented in various forms without departing from the gist of the present disclosure. For example, in the above-described embodiment, the battery cover 22 is also used as a floor panel, but the present disclosure is not limited thereto. That is, a separate floor panel may be provided above the battery cover 22. Even in this case, if the cross member protrudes upward from the floor panel, the same effect as in the above-described embodiment is obtained. However, from the viewpoint of securing the vehicle cabin space and reducing the number of components, it is preferable to use a structure in which the battery cover and the floor panel are shared.

Further, in the above-described embodiment, one cross member 20 is provided in the frame-shaped member 12, but the present disclosure is not limited thereto. For example, a plurality of cross members may be provided in the frame-shaped member 12. However, from the viewpoint of securing the storage area of the battery BT, it is preferable that only one cross member 20 is provided. At this time, by disposing the cross member 20 in the center of the frame-shaped member 12 in the vehicle front-rear direction, it is possible to effectively transmit the load.

Further, in the above-described embodiment, the rocker 30 is disposed on the vehicle width direction outer side of the frame-shaped member 12, but the present disclosure is not limited thereto. For example, except for the rocker, the first frame 14 may function as a rocker. In this case, the second frame 16 functions as a cross member connecting the rockers. In addition, since the rocker is not provided, a larger storage area of the battery can be secured.

With respect to the above embodiments, the following supplementary notes are disclosed.

### Appendix 1

A frame-shaped member formed in a frame shape including a pair of left and right first frames extending in the vehicle front-rear direction, and a pair of front and rear second frames extending in the vehicle width direction, the battery can be accommodated inside,
A battery cover provided on an upper surface of the frame-shaped member and extending in the vehicle front-rear direction and the vehicle width direction,
A pair of left and right of the first frame is connected extending in the vehicle width direction, and a cross member protruding to the vehicle cabin above the battery cover,
A vehicle lower part structure comprising:

### Appendix 2

The vehicle lower part structure according to claim 1, wherein both end portions of the cross member are superposed on an upper surface of the first frame.

### Appendix 3

The vehicle lower part structure according to claim 1 or 2, wherein the cross member is provided with an attachment portion for mounting the vehicle seat.

### Appendix 4

A rocker extending in the vehicle front-rear direction is provided outside the frame-shaped member in the vehicle width direction,
The vehicle lower part structure according to any one of Appendices 1 to 3, wherein the first frame is attached to the rocker.

### Appendix 5

The vehicle lower part structure according to any one of Appendices 1 to 4, wherein the battery cover is a floor panel constituting a floor surface of a vehicle cabin.

What is claimed is:

1. A vehicle lower part structure comprising:
a frame-shaped member having a frame shape including a pair of right and left first frames extending in a vehicle front-rear direction and a pair of front and rear second frames extending in a vehicle width direction, the frame-shaped member being configured to house a battery inside;
a battery cover provided on an upper surface of the frame-shaped member and extending in the vehicle front-rear direction and the vehicle width direction; and
a cross member extending in the vehicle width direction, connecting the right and left first frames, and protruding into a vehicle cabin above the battery cover.

2. The vehicle lower part structure according to claim 1, wherein both ends of the cross member are laid on upper surfaces of the first frames.

3. The vehicle lower part structure according to claim 1, wherein the cross member includes an attachment portion for attachment of a vehicle seat.

4. The vehicle lower part structure according to claim 1, wherein:
a rocker extending in the vehicle front-rear direction is provided outside the frame- shaped member in the vehicle width direction; and
the first frame is attached to the rocker.

5. The vehicle lower part structure according to claim 1, wherein the battery cover is a floor panel constituting a floor surface of the vehicle cabin.
